(19) United States
(12) Patent Application Publication
(10) Pub. No.: US 2023/0192388 A1
(43) Pub. Date: Jun. 22, 2023

(54) HEAT INSULATION PIZZA BOX

(71) Applicant: GENICOOK PRODUCT, LLC, GARLAND, TX (US)

(72) Inventors: Jianzhong Zhang, Handan (CN); Jiehao Yan, Handan (CN)

(73) Assignee: GENICOOK PRODUCT, LLC, GARLAND, TX (US)

(21) Appl. No.: 18/108,685

(22) Filed: Feb. 13, 2023

(30) Foreign Application Priority Data
Jan. 10, 2023 (CN) 202320070573.6

(51) Int. Cl. B65D 81/38; B65D 45/18; B65D 25/28; B65D 51/16

(52) U.S. Cl. CPC B65D 81/3811; B65D 45/18; B65D 25/2838; B65D 51/1672; B65D 2585/366; B65D 2543/00305; B65D 2543/00972

(57) ABSTRACT

The present invention relates to the technical field of pizza boxes, comprising a box body and a top cover. The box body and the top cover have triangular sector structures. The top end of the box body is open, and the edge of the open end extends outward to form a clamping flange; a lower end surface of the top cover is hermetically abutted against an upper end surface of the clamping flange; the side wall of the top cover is hinged with a plurality of claw buckles along a circumferential direction; the claw buckles have clamping plates and are clamped with the lower end surface of the clamping flange; and the bottom of the box body and the edge of the top cover are wrapped with heat insulation layers. The heat insulation pizza box of the present invention has good sealing and heat insulation effects.

### TECHNICAL FIELD

The present invention relates to the technical field of pizza boxes, and particularly relates to a heat insulation pizza box.

### BACKGROUND

Pizza, also known as pizza pie, pisa, pisa pie, pizza cake and pizza pancake, is a food originated from Italy.

When eating pizza, people sometimes need to store the rest pizza, to store the rest pizza into a refrigerator or heat the rest pizza in a microwave oven before eating. At present, there are paper or plastic disposable pizza packaging boxes on the market. It is inconvenient for storing the rest pizza. Firstly, when the rest pizza is stored in a refrigerator, the rest pizza is poor in sealing performance and is prone to taint of odor with other foods in the refrigerator. Secondly, the rest pizza has high temperature after heated in a microwave oven, and the existing pizza box is easy to scald the hand and inconvenient to take up and carry.

Therefore, with respect to the above problems in the prior art, the technical problem to be urgently solved by those skilled in the art is to provide a pizza box with sealing and heat insulation functions.

### SUMMARY

A technical problem to be solved by the present invention is to provide a heat insulation pizza box with good sealing and heat insulation effects.

A technical solution of the present invention for solving the above technical problem is as follows:

A heat insulation pizza box comprises a box body and a top cover for covering the box body. The box body and the top cover have triangular sector structures. The top end of the box body is open, and the edge of the open end extends outward to form a clamping flange; a lower end surface of the top cover is hermetically abutted against an upper end surface of the clamping flange; the side wall of the top cover is hinged with a plurality of claw buckles along a circumferential direction; the claw buckles have clamping plates and are clamped with the lower end surface of the clamping flange; and the bottom of the box body and the edge of the top cover are wrapped with heat insulation layers.

The present invention has the beneficial effects that: the box body with the triangular sector structure is used for storing a plurality of pizza triangular slices; the top cover is covered on the open end of the box body and a contact surface has a seal structure to improve the sealing effect for storage of the pizza box. The top cover and the box body are opened or closed by the claw buckles and the clamping flange; and the box body and the top cover are wrapped with the heat insulation layers, so that the pizza box has a good heat insulation effect, and achieves heat insulation and anti-scalding effects when a heated pizza is stored.

On the basis of the above technical solution, the present invention can also be improved as follows.

Further, the heat insulation layers comprise a first heat insulation layer and a second heat insulation layer; the first heat insulation layer comprises a horizontal first wrapping part and a second wrapping part extending upward perpendicular to the edge of the first wrapping part; the first wrapping part and the second wrapping part define a first groove fitted with the bottom of the box body and wrapped; the second heat insulation layer comprises a vertical third wrapping part and a fourth wrapping part extending horizontally perpendicular to the edge of the third wrapping part; and the third wrapping part and the fourth wrapping part define a second groove fitted with the edge of the top cover and wrapped.

The above further solution has the following beneficial effects: when a user takes up the pizza box, hands usually touch the bottom of the pizza box and the edge of the top cover. The heat insulation layers are arranged at the corresponding parts to achieve the heat insulation and anti-scalding effects.

Further, the side wall of the top cover protrudes outwards to form a raised clamping structure; the raised clamping structure comprises a first bump, a second bump and a hinging shaft; the first bump and the second bump are arranged oppositely; the hinging shaft is connected to the opposite side of the first bump and the second bump; and the claw buckles are hinged with the hinging shaft.

The above further solution has the following beneficial effects: the claw buckles rotate with the hinging shaft as a center to realize the opening or closing of the top cover and the box body.

Further, each claw buckle comprises a hinging part, a buckling part and the clamping plate; the hinging part is a ring structure with a section greater than ½ circle and is hinged with the hinging shaft; one end of the hinging part away from the hinging shaft is integrally connected with the buckling part; the outer side wall of the buckling part is inclined downwards away from the box body; the clamping plate is perpendicular to the inner side wall of the buckling part, and an upper end surface is clamped with the lower end surface of the clamping flange.

The above further solution has the following beneficial effects: the outer side wall of the buckling part is inclined to the outer side at a certain angle, which is convenient for the user to apply force on the buckling part to open or close the top cover.

Further, the upper end surface of the top cover is provided with a heat dissipation hole which penetrates through the top cover and a heat dissipation cover for covering the heat dissipation hole; the heat dissipation cover comprises a plug and a clamping ring; an outer ring of the clamping ring is adaptively clamped with the heat dissipation hole; the plug is in T type; the outer side end of a transverse plate is rotatably connected with the clamping ring, and a vertical plate is an inserting block which extends downwards; and the inserting block is adapted to and slidably inserted with an inner ring of the clamping ring.

The above further solution has the following beneficial effects: when the pizza in the pizza box needs heat dissipation, the user only needs to apply upward force on the heat dissipation cover, the plug slides out from the heat dissipation hole and the interior of the box body is communicated with the outside through the heat dissipation hole for heat dissipation.

Further, the top cover is made of high borosilicate glass material; and the box body is made of high borosilicate glass material or stainless steel material.

The above further solution has the following beneficial effects: when the top cover and the box body are made of the high borosilicate glass material, the pizza box can be heated directly in a microwave oven or an oven; the link of putting the pizza into a baking tray is eliminated in the process of heating the pizza; and thus there is no trouble of cleaning the baking tray for the user. Because of the heat insulation and anti-scalding effects of the heat insulation layers, the user can take up and carry the pizza immediately after the pizza is heated in the oven.

Further, the side wall of the box body is hinged with a bracket handle, and the bracket handle can be rotated upward and buckled on the top cover.

The above further solution has the following beneficial effects: it is convenient to take up and carry the pizza box through the bracket handle. When placed, the bracket handle can be rotated and buckled on the top end of the top cover to reduce space occupation.

Further, the lower end surface of the top cover is sunk inwards to form a sealing groove; and a sealing ring is installed in the sealing groove and is hermetically abutted against the upper end surface of the clamping flange.

The above further solution has the following beneficial effects: the top cover and the box body are sealed by the sealing ring, which has a good sealing effect.

### DESCRIPTION OF DRAWINGS

FIG. 1 is a three-dimensional structural schematic diagram of a specific embodiment of a heat insulation pizza box in the present invention;

FIG. 2 is a top view of FIG. 1;

FIG. 3 is a side view of FIG. 1;

FIG. 4 is a sectional view of A-A section in FIG. 2;

FIG. 5 is a sectional view of B-B section in FIG. 2;

FIG. 6 is a three-dimensional structural schematic diagram of another specific embodiment of a heat insulation pizza box in the present invention; and

FIG. 7 is a top view of FIG. 6.

A list of components represented by legends in the figures is as follows:
1—box body; 2—top cover; 3—claw buckle; 4—sealing ring; 5—heat insulation layer; 6—raised clamping structure; 7—heat dissipation cover; 8—bracket handle; 11—clamping flange; 31—clamping plate; 32—hinging part; 33—buckling part; 51—first heat insulation layer; 52—second heat insulation layer.

### DETAILED DESCRIPTION

The principles and features of the present invention will be described below in combination with drawings. Described examples are only used for explaining the present invention, but are not intended to limit the scope of the present invention.

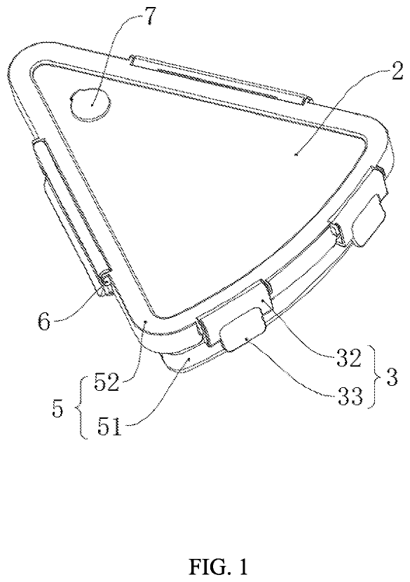

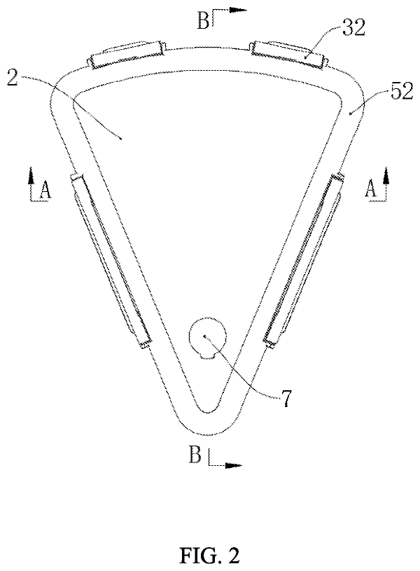

As shown in FIG. 1 to FIG. 7, embodiments of the present invention disclose a heat insulation pizza box, comprising a box body 1 and a top cover 2 for covering the box body 1. The box body 1 and the top cover 2 have triangular sector structures. The top end of the box body 1 is open, and the edge of the open end extends outwards to form a clamping flange; a lower end surface of the top cover 2 is hermetically abutted against an upper end surface of the clamping flange 11; the side wall of the top cover 2 is hinged with a plurality of claw buckles 3 along a circumferential direction; the claw buckles 3 have clamping plates 31 and are clamped with the lower end surface of the clamping flange 11; and the bottom of the box body 1 and the edge of the top cover 2 are wrapped with heat insulation layers 5. In a specific embodiment, the box body 1 has a sector with the size of a side length of 203 mm (8 inches), and can contain triangular slices of the common largest 406 mm (16 inches) pizza on the current market. This pizza box can store 4-5 slices of triangular sliced pizza.

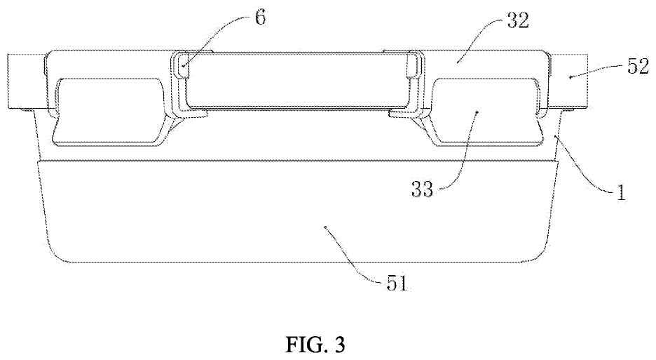

To further optimize the above technical solution, as shown in FIG. 1 and FIG. 3, the heat insulation layers 5 comprise a first heat insulation layer 51 and a second heat insulation layer 52; the first heat insulation layer 51 comprises a horizontal first wrapping part and a second wrapping part extending upward perpendicular to the edge of the first wrapping part; the first wrapping part and the second wrapping part define a first groove fitted with the bottom of the box body 1 and wrapped; the second heat insulation layer 52 comprises a vertical third wrapping part and a fourth wrapping part extending horizontally perpendicular to the edge of the third wrapping part; and the third wrapping part and the fourth wrapping part define a second groove fitted with the edge of the top cover 2 and wrapped.

To further optimize the above technical solution, as shown in FIG. 3, the side wall of the top cover 2 protrudes outwards to form a raised clamping structure 6; the raised clamping structure 6 comprises a first bump, a second bump and a hinging shaft; the first bump and the second bump are arranged oppositely; the hinging shaft is connected to the opposite side of the first bump and the second bump; and the claw buckles 3 are hinged with the hinging shaft.

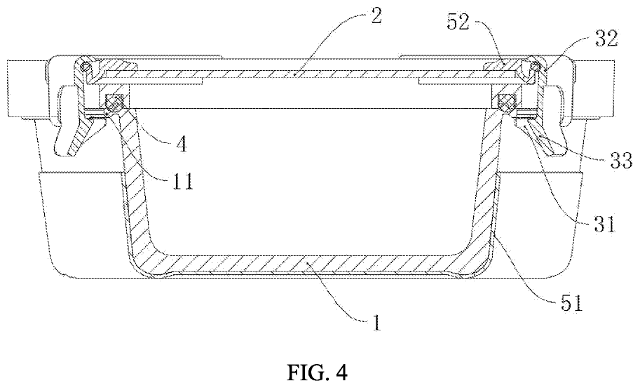

To further optimize the above technical solution, as shown in FIG. 4, each claw buckle 3 comprises a hinging part 32, a buckling part 33 and the clamping plate 31; the hinging part 32 is a ring structure with a section greater than ½ circle and is hinged with the hinging shaft; one end of the hinging part away from the hinging shaft is integrally connected with the buckling part 32; the outer side wall of the buckling part 32 is inclined downwards away from the box body 1; the clamping plate 31 is perpendicular to the inner side wall of the buckling part 32, and an upper end surface is clamped with the lower end surface of the clamping flange 11.

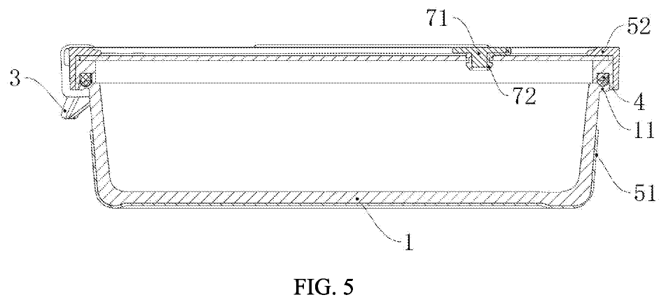

To further optimize the above technical solution, as shown in FIG. 5, the upper end surface of the top cover 2 is provided with a heat dissipation hole which penetrates through the top cover and a heat dissipation cover 7 for covering the heat dissipation hole; the heat dissipation cover 7 comprises a plug 71 and a clamping ring 72; an outer ring of the clamping ring 72 is adaptively clamped with the heat dissipation hole; the plug 71 is in T type; the outer side end of a transverse plate is rotatably connected with the clamping ring 72, and a vertical plate is an inserting block which extends downwards; and the inserting block is adapted to and slidably inserted with an inner ring of the clamping ring 72. The side wall of the outer ring of the clamping ring 72 has a groove and is adaptively clamped with the heat dissipation hole.

To further optimize the above technical solution, the top cover 2 is made of high borosilicate glass material; and the box body 1 is made of high borosilicate glass material or stainless steel material.

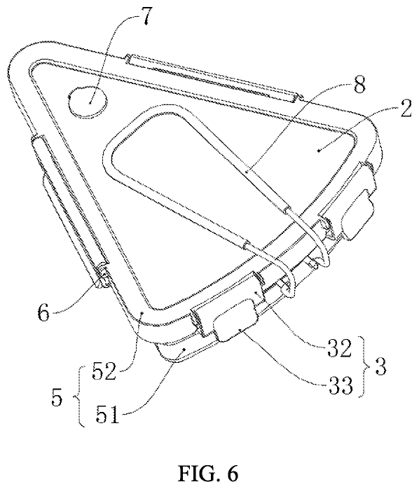

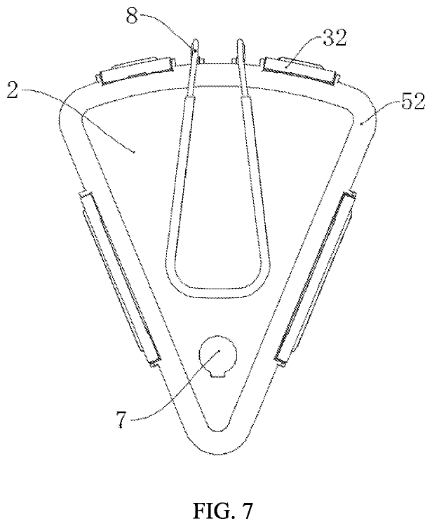

To further optimize the above technical solution, as shown in FIG. 6 and FIG. 7, the side wall of the box body 1 is hinged with a bracket handle 8, and the bracket handle 8 can be rotated upward and buckled on the top cover 2.

To further optimize the above technical solution, the heat insulation layers 5 are rubber heat insulation layers.

To further optimize the above technical solution, as shown in FIG. 4 and FIG. 5, the lower end surface of the top cover 2 is sunk inwards to form a sealing groove; and a sealing ring 4 is installed in the sealing groove and is hermetically abutted against the upper end surface of the clamping flange 11.

When the heat insulation pizza box of the present invention is used, a plurality of pizza slices are stored vertically in the triangular sectorial box body 1. Compared with the horizontal expansion storage mode of a plurality of pizza slices, the occupied area is reduced and it is convenient for storage in the refrigerator or heating in the microwave oven. The top cover 2 realizes closing with the box body 1 through a plurality of claw buckles 3, and the contact surfaces of the top cover 2 and the box body 1 are sealed through the sealing ring 4, so as to avoid taint of odor with other foods during storage in the refrigerator.

The box body 1 can be used for storing heated pizza slices, and it is convenient for the users to take up and carry the pizza box through the heat insulation and anti-scalding effects of the heat insulation layer 51 and the heat insulation layer 52. The box body 1 can be made of high borosilicate glass material, and at this moment, the pizza box can be heated directly in the microwave oven. The box body 1 can also be made of stainless steel material, and the side wall of the box body 1 is provided with the bracket handle 8, which is convenient to take up the pizza box through the bracket handle 8. The bracket handle 8 can be folded and buckled on the top cover 2, to reduce the occupation of space.

According to the contact position between the hand and the pizza box when the user takes up the pizza box, the bottom surface and the lower part of the side wall of the box body 1 are wrapped with the heat insulation layer 51, and the side wall of the top cover 2 and the edge of the top surface are wrapped with the heat insulation layer 52, to achieve good heat insulation and anti-scalding effects. The heat insulation layer 51 and the heat insulation layer 52 can be made of rubber heat insulation material.

The user can also open the heat dissipation cover 7, so that the interior of the box body 1 is communicated with the outside for slow heat dissipation, thereby improving the use convenience of the pizza box.

The above only describes preferred embodiments of the present invention and is not intended to limit the present invention. Any modification, equivalent replacement, improvement, etc. made within the spirit and the principle of the present invention shall be included within the protection scope of the present invention.

What is claimed is:

1. A heat insulation pizza box, comprising a box body (1) and a top cover (2) for covering the box body (1), wherein the box body (1) and the top cover (2) have triangular sector structures; the top end of the box body (1) is open, and the edge of the open end extends outwards to form a clamping flange (11); a lower end surface of the top cover (2) is hermetically abutted against an upper end surface of the clamping flange (11); the side wall of the top cover (2) is hinged with a plurality of claw buckles (3) along a circumferential direction; the claw buckles (3) have clamping plates (31) and are clamped with the lower end surface of the clamping flange (11); and the bottom of the box body (1) and the edge of the top cover (2) are wrapped with heat insulation layers (5).

2. The heat insulation pizza box according to claim 1, wherein the heat insulation layers (5) comprise a first heat insulation layer (51) and a second heat insulation layer (52);
the first heat insulation layer (51) comprises a horizontal first wrapping part and a second wrapping part extending upward perpendicular to the edge of the first wrapping part; the first wrapping part and the second wrapping part define a first groove fitted with the bottom of the box body (1) and wrapped;
the second heat insulation layer (52) comprises a vertical third wrapping part and a fourth wrapping part extending horizontally perpendicular to the edge of the third wrapping part; and the third wrapping part and the fourth wrapping part define a second groove fitted with the edge of the top cover (2) and wrapped.

3. The heat insulation pizza box according to claim 1, wherein the side wall of the top cover (2) protrudes outwards to form a raised clamping structure (6); the raised clamping structure (6) comprises a first bump, a second bump and a hinging shaft; the first bump and the second bump are arranged oppositely; the hinging shaft is connected to the opposite side of the first bump and the second bump; and the claw buckles (3) are hinged with the hinging shaft.

4. The heat insulation pizza box according to claim 3, wherein each claw buckle (3) comprises a hinging part (32), a buckling part (33) and the clamping plate (31); the hinging part (32) is a ring structure with a section greater than ½ circle and is hinged with the hinging shaft; one end of the hinging part away from the hinging shaft is integrally connected with the buckling part (32); the outer side wall of the buckling part (32) is inclined downwards away from the box body (1); the clamping plate (31) is perpendicular to the inner side wall of the buckling part (32), and an upper end surface is clamped with the lower end surface of the clamping flange (11).

5. The heat insulation pizza box according to claim 1, wherein the upper end surface of the top cover (2) is provided with a heat dissipation hole which penetrates through the top cover and a heat dissipation cover (7) for covering the heat dissipation hole; the heat dissipation cover (7) comprises a plug (71) and a clamping ring (72); an outer ring of the clamping ring (72) is adaptively clamped with the heat dissipation hole; the plug (71) is in T type; the outer side end of a transverse plate is rotatably connected with the clamping ring (72), and a vertical plate is an inserting block which extends downwards; and the inserting block is adapted to and slidably inserted with an inner ring of the clamping ring (72).

6. The heat insulation pizza box according to claim 1, wherein the top cover (2) is made of high borosilicate glass material; and the box body (1) is made of high borosilicate glass material or stainless steel material.

7. The heat insulation pizza box according to claim 6, wherein the side wall of the box body (1) is hinged with a bracket handle (8), and the bracket handle (8) can be rotated upward and buckled on the top cover (2).

8. The heat insulation pizza box according to claim 1, wherein the heat insulation layers (5) are rubber heat insulation layers.

9. The heat insulation pizza box according to claim 1, wherein the lower end surface of the top cover (2) is sunk inwards to form a sealing groove; and a sealing ring (4) is installed in the sealing groove and is hermetically abutted against the upper end surface of the clamping flange (11).

10. The heat insulation pizza box according to claim 2, wherein the lower end surface of the top cover (2) is sunk inwards to form a sealing groove; and a sealing ring (4) is installed in the sealing groove and is hermetically abutted against the upper end surface of the clamping flange (11).

11. The heat insulation pizza box according to claim 3, wherein the lower end surface of the top cover (2) is sunk inwards to form a sealing groove; and a sealing ring (4) is installed in the sealing groove and is hermetically abutted against the upper end surface of the clamping flange (11).

12. The heat insulation pizza box according to claim 4, wherein the lower end surface of the top cover (2) is sunk inwards to form a sealing groove; and a sealing ring (4) is installed in the sealing groove and is hermetically abutted against the upper end surface of the clamping flange (11).

13. The heat insulation pizza box according to claim 5, wherein the lower end surface of the top cover (2) is sunk inwards to form a sealing groove; and a sealing ring (4) is installed in the sealing groove and is hermetically abutted against the upper end surface of the clamping flange (11).

14. The heat insulation pizza box according to claim 6, wherein the lower end surface of the top cover (2) is sunk inwards to form a sealing groove; and a sealing ring (4) is installed in the sealing groove and is hermetically abutted against the upper end surface of the clamping flange (11).

15. The heat insulation pizza box according to claim 7, wherein the lower end surface of the top cover (2) is sunk inwards to form a sealing groove; and a sealing ring (4) is installed in the sealing groove and is hermetically abutted against the upper end surface of the clamping flange (11).

16. The heat insulation pizza box according to claim 8, wherein the lower end surface of the top cover (2) is sunk inwards to form a sealing groove; and a sealing ring (4) is installed in the sealing groove and is hermetically abutted against the upper end surface of the clamping flange (11).
